(19) United States
(12) Patent Application Publication
(10) Pub. No.: US 2003/0055201 A1
(43) Pub. Date: Mar. 20, 2003

(54) Process for optimising the production of polycarbonate by melt transesterification

(76) Inventors: Silke Kratschmer, Krefeld (DE); Lothar Bunzel, Kempen (DE); Siegfried Neumann, Tonisvorst (DE)

Correspondence Address: BAYER CORPORATION, PATENT DEPARTMENT, 100 BAYER ROAD, PITTSBURGH, PA, 15205, US

(21) Appl. No.: 10/214,078

(22) Filed: Aug. 7, 2002

(30) Foreign Application Priority Data
Aug. 10, 2001 (DE) 10139530.2

(51) Int. Cl. C08G 64/00

(52) U.S. Cl. 528/196

(57) ABSTRACT

A process for determining the suitability of a specific raw material entailed in the melt transesterification of polycarbonate is disclosed. The process entails melting the raw materials including the specific raw material in a reaction vessel and measuring the elapsed time until formation of the first drop of the hydroxyl compound.

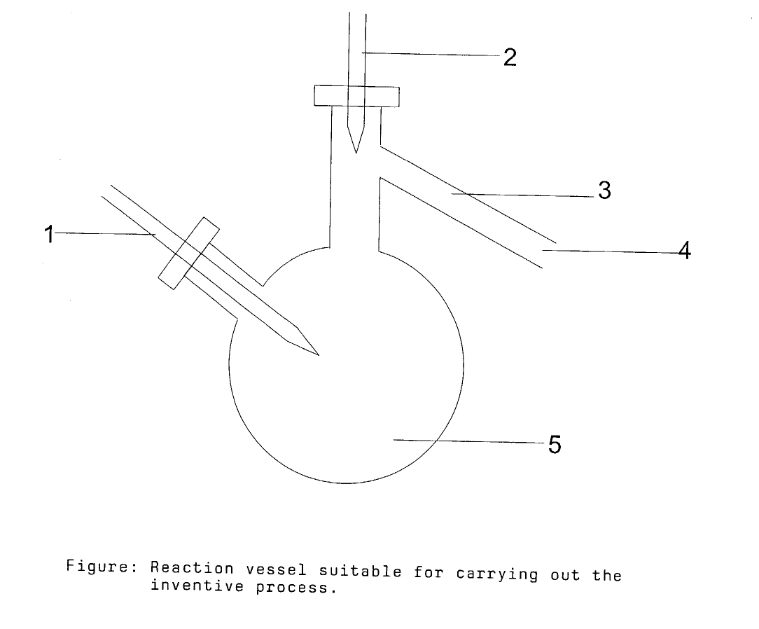

### FIELD OF THE INVENTION

The invention concerns the production of polycarbonates by melt transesterification and more particularly to a process for determining the quality of raw materials for said production.

### SUMMARY OF THE INVENTION

A process for determining the suitability of a specific raw material entailed in the melt transesterification of polycarbonate disclosed. The process entails melting the raw materials including the specific raw material in a reaction vessel and measuring the elapsed time until formation of the first drop of the hydroxyl compound. BACKGROUND OF THE INVENTION

Details of the melt transesterification process are described in the literature (see for example Hermann Schnell, Chemistry and Physics of Polycarbonates, Polymer Reviews, Vol. 9, 1964, pages 44 to 51, DE-A-1 031 512, U.S. Pat. No. 3,022,272, U.S. Pat. No. 5,340,905 and U.S. Pat. No. 5,399,659).

It is also known that the raw materials for melt transesterification should be as pure as possible in order to obtain a high-quality polycarbonate. This is described, e.g., by reference to the diphenyl carbonate component in EP-A 592 900 or EP-A 251 168 and for the purity of the bisphenol component in JP-A 2000 198 838 or JP-A 11 335 454.

The purity of the raw materials is critical for the melt condensation, since impurities may have both a catalytic and a deactivating effect on the reaction progress. In order to obtain the best possible reaction course it is therefore useful to know the autocatalytic activity of the raw materials before they are introduced into the melt transesterification. “Autocatalytic activity” refers to the catalytic activity already present in the raw materials, which may derive from the raw material compounds themselves or from impurities contained within the raw materials.

EP-A 849 306 describes a process for measuring the effective catalyst concentration. The raw materials are melted together with the catalyst, the resulting amount of monophenol measured and the effective catalyst level determined. If this variable is known, the amount of catalyst may be adjusted. This process requires a complex analytical process, however, in order to determine the concentration of monophenol in addition to diphenol.

Starting from the prior art the object was therefore to find a simple and fast process for determining the purity of the raw materials or their effect on the course of the melt transesterification process.

### DESCRIPTION OF THE FIGURE

The figure shows a vessel suitable for carrying out the inventive process.

### DETAILED DESCRIPTION OF THE INVENTION

It has been found that a surprisingly fast and simple test is possible for testing the quality of raw materials with regard to their autocatalytic activity.

The present invention provides a process for determining the quality of raw materials for the melt transesterification of polycarbonate. The process comprise melting the raw materials in a reaction vessel and measuring the time elapsing until formation of the first drop of hydroxyl component.

The process may be performed with or without catalyst, depending on the point of reference, whereby the reaction time is significantly reduced by the addition of catalyst.

A test run with raw materials of known quality or of known associated process parameters, with or without catalyst, is chosen as point of reference. The subsequent tests must accordingly likewise be performed with or without catalyst.

In addition to the catalyst, the other conventional components such as branching agents, etc., may also be added in the test. This must then also be done in the reference experiment. The more components that are used in a test, however, the more additional influences have to be taken into account in addition to the quality of the raw materials.

The addition of catalyst therefore primarily serves to shorten the test unless the catalyst itself is being tested.

A preferred reaction vessel is a glass unit such as shown in the attached Figure. The vessel is a 100 ml round-bottomed flask e, equipped with distillation bridge c, bottom thermometer a, and overhead thermometer b.

According to a preferred mode of operation, the dihydroxyl compound, the dicarboxylic acid diester and optionally catalyst or optionally other components such as branching agents or additives are placed in a reaction vessel and melted. The mixture is stirred and the time elapsing to the elimination of the first drop of the hydroxyl compound to be collected at the end of the distillation tube d, is measured.

It is important that the test conditions, such as heating method, catalyst use, pressure, construction of the test apparatus or other parameters, such as the quality of the components other than the component to be tested, are maintained the same within each series of tests in order to obtain comparable results. On the basis of these results the parameters of the actual melt transesterification process may then either be adjusted to the raw materials accordingly or, e.g., the raw materials or the addition of catalyst may be adjusted. The results of the test method, a uniform reaction course for the melt transesterification process, is attained as is a consistent quality of the resulting poly-carbonate.

If for example the catalyst is tested, the quality of the other educts, such as bisphenols and diaryl carbonates, must be kept constant within a test series, whereby educts from the same batch or delivery are preferably always used in order to obtain comparable results, from which the suitable measures may then be deduced.

According to the test results obtained, the mode of operation, i.e., the amount of catalyst added, temperature, pressure, residence time, mixing ratio of the educts or other parameters, may be adjusted in the actual melt transesterification process in such a way that optimal results may be obtained from the tested raw materials. The test results must be adjusted for each plant in which polycarbonate is to be produced by the melt transesterification process. This means that experiments must be performed to determine which measures must be taken in the reaction course in response to which test results, in order to ensure an optimum result, since each plant displays its own range of properties.

The melt transesterification process is known to start from, e.g., aromatic dihydroxyl compounds, carbonic acid diesters, catalysts and optionally other additive substances; therefore these components are referred to as raw materials within the meaning of the present invention. Dihydroxyl compounds as a raw material within the meaning of the invention are those having the formula (I)

HO—Z—OH (I),

in which Z is an aromatic radical having 6 to 30 C atoms, which may contain one or more aromatic nuclei, may be substituted and may contain aliphatic or cycloaliphatic radicals or alkylaryls or hetero atoms.

Examples of dihydroxyl compounds having the formula (I) are hydroquinone,

resorcinol,

dihydroxydiphenyls,

bis(hydroxyphenyl) alkanes,

bis(hydroxyphenyl) cycloalkanes,

bis(hydroxyphenyl) sulfides,

bis(hydroxyphenyl) ethers,

bis(hydroxyphenyl) ketones,

bis(hydroxyphenyl) sulfones,

bis(hydroxyphenyl) sulfoxides,

α,α′-bis(hydroxyphenyl) diisopropyl benzenes

as well as ring-alkylated and ring-halogenated compounds thereof.

These and other suitable alternative diphenols are described for example in U.S. 3,028,365, 3,148,172, 3,275,601, 2,991,273, 3,271,367, 3,062,781, 2,970,131 and 2,999,846, in DE-A 1 570 703, 2 063 050, 2 063 052, 2 211 0956, in the French patent specification 1 561 518 and in the monograph “H. Schnell, Chemistry and Physics of Polycarbonates, Interscience Publishers, New York 1964 page 77 ff”, all incorporated by reference herein.

Preferred diphenols are for example:

4,4′-dihydroxydiphenyl,

2,2-bis(4-hydroxyphenyl) propane,

2,4-bis(4-hydroxyphenyl)-2-methylbutane,

1,1-bis(4-hydroxyphenyl) cyclohexane,

1,1-bis(4-hydroxyphenyl)-4-methylcyclohexane,

α,α′-bis(4-hydroxyphenyl)-p-diisopropylbenzene,

α,α′-bis(4-hydroxyphenyl)-m-diisopropylbenzene,

bis(4-hydroxyphenyl) sulfone,

bis(4-hydroxyphenyl) methane,

1,1-bis(4-hydroxyphenyl)-3,3,5-trimethyl cyclohexane,

2,2-bis(2,6-dimethyl-4-hydroxyphenyl) propane,

2,2-bis(4-hydroxyphenyl) hexafluoropropane,

1,1-(4-hydroxyphenyl)-1-phenylethane,

bis(4-hydroxyphenyl) diphenylmethane,

dihydroxydiphenylether,

4,4′-thiobisphenol,

1,1-bis(4-hydroxyphenyl)-1-(1-naphthyl)ethane,

1,1-bis(4-hydroxyphenyl)-1-(2-naphthyl)ethane,

2,3-dihydroxy-3-(4-hydroxyphenyl)-1,1,3-trimethyl-1 H-inden-5-ol,

2,3-dihydroxy-1-(4-hydroxyphenyl)-1,3,3-trimethyl-1 H-inden-5-ol,

2,2′,3,3′-tetrahydro-3,3,3′,3′-tetramethyl-1,1′-spirobi[1 H-indene]-5,5′-diol.

Particularly preferred are

4,4′-dihydroxydiphenyl,

resorcinol,

1,1-bis(4-hydroxyphenyl)-1-(1-naphthyl) ethane,

1,1-bis(4-hydroxyphenyl)-1-(2-naphthyl) ethane,

2,2-bis(4-hydroxyphenyl) propane,

α,α′-bis(4-hydroxyphenyl)-p-diisopropylbenzene,

α,α′-bis(4-hydroxyphenyl)-m-diisopropylbenzene,

1,1-bis(4-hydroxyphenyl) cyclohexane,

1,1-bis(4-hydroxyphenyl)-3,3,5-trimethyl cyclohexane,

bis(4-hydroxyphenyl) diphenylmethane.

2,2-bis(4-hydroxyphenyl) propane is most particularly preferred.

Both one diphenol having formula (I) to form homopolycarbonates and more than one diphenol having formula (I) to form copolycarbonates may be tested.

Carbonic acid diesters as raw materials within the meaning of the invention are those having the formula (II) and (III)

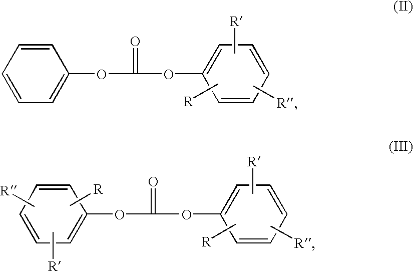

whereby

R, R′ and R″ may independently one of the others denote H, optionally branched C₁-C₃₄ alkyl/cycloalkyl, C₇-C₃₄ alkaryl or C₆-C₃₄ aryl,

for example

diphenyl carbonate,

butylphenyl phenyl carbonate, dibutylphenyl carbonate,

isobutylphenyl phenyl carbonate, diisobutylphenyl carbonate,

tert-butylphenyl phenyl carbonate, di-tert-butylphenyl carbonate,

n-pentylphenyl phenyl carbonate, di-(n-pentylphenyl) carbonate,

n-hexylphenyl phenyl carbonate, di-(n-hexylphenyl) carbonate,

cyclohexylphenyl phenyl carbonate, dicyclohexylphenyl carbonate,

phenylphenol phenyl carbonate, diphenylphenol carbonate,

isooctylphenyl phenyl carbonate, diisooctylphenyl carbonate,

n-nonylphenyl phenyl carbonate, di-(n-nonylphenyl) carbonate,

cumylphenyl phenyl carbonate, dicumylphenyl carbonate,

naphthylphenyl phenyl carbonate, dinaphthylphenyl carbonate,

di-tert-butylphenyl phenyl carbonate, di-(di-tert-butylphenyl) carbonate,

dicumylphenyl phenyl carbonate, di-(dicumylphenyl) carbonate,

4-phenoxyphenyl phenyl carbonate, di-(4-phenoxyphenyl) carbonate,

3-pentadecylphenyl phenyl carbonate, di-(3-pentadecylphenyl) carbonate,

tritylphenyl phenyl carbonate, ditritylphenyl carbonate,

preferably

diphenyl carbonate,

tert-butylphenyl phenyl carbonate, di-tert-butylphenyl carbonate,

phenylphenol phenyl carbonate, diphenylphenol carbonate,

cumylphenyl phenyl carbonate, dicumylphenyl carbonate,

particularly preferably diphenyl carbonate.

Mixtures of the cited carbonic acid diesters may also be used.

The content of carbonic acid ester is 100 to 130 mol%, preferably 103 to 120 mol%, particularly preferably 103 to 109 mol%, relative to the dihydroxyl compound.

Catalysts within the meaning of the invention are ammonium or phosphonium salts, referred to below as onium salts. Phosphonium salts within the meaning of the invention are those having the formula (IV)

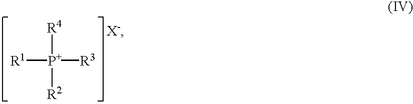

whereby

R¹⁻⁴ independently one of the others denote C₁-C₁₀ alkyls, C₆-C₁₀ aryls, C₇-C₁₀ aralkyls or C₅-C₆ cycloalkyls, preferably methyl or C₆-C₁₄ aryls, particularly preferably methyl or phenyl, and

X³¹ denotes an anion such as hydroxide, sulfate, hydrogen sulfate, hydrogen carbonate, carbonate, a halide, preferably chloride, or an alcoholate having the formula OR, whereby R may be C₆-C₁₄ aryl or C₇-C₁₂ aralkyl, preferably phenyl.

Preferred catalysts are

tetraphenyl phosphonium chloride,

tetraphenyl phosphonium hydroxide,

tetraphenyl phosphonium phenolate,

particularly preferably tetraphenyl phosphonium phenolate.

They are preferably used in quantities of 10⁻⁸ to 10⁻³ mol, relative to one mol of bisphenol, particularly preferably in quantities of 10⁻⁷ to 10⁻⁴ mol.

Other catalysts may be used alone or optionally in addition to the onium salt in order to increase the rate of polymerization. They include salts of alkaline metals and alkaline-earth metals, such as hydroxides, alkoxides and aryloxides of lithium, sodium and potassium, preferably hydroxide, alkoxide or aryloxide salts of sodium. Sodium hydroxide and sodium phenolate are most preferred. The amounts of co-catalyst may range from 1 to 200 ppb, preferably 5 to 150 ppb and most preferably 10 to 125 ppb, calculated in each case as sodium.

The catalysts themselves may also be considered as raw materials within the meaning of the present invention and may be tested by the test method according to the invention.

Depending on the type and amount of raw materials added, in particular of the catalyst added, the elapsed time to the formation of the first drop of hydroxyl component varies.

The tested raw materials may be used in the melt transesterification. The raw materials may be used either directly or after purification, or the melt transesterification may be optimized according to the determined quality of the raw materials.

In addition to the catalysts that have already been cited and that are optionally tested, other additive substances in the melt polycarbonate process may for example be branching agents or additives. Suitable branching agents are the suitable compounds for polycarbonate production having three or more functional groups, preferably those having three or more phenolic OH groups, for example branching agents such as are cited in EP-A 708 130, page 4, preferably 1,1,1-tri(4-hydroxyphenyl) ethane and isatin biscresol.

The polycarbonates obtained may be supplemented with additives and processed conventionally. Suitable additives are described, e.g., in WO 99/55772, page 15 to 25, and in “Plastics Additives”, R. Gächter and H. Muller, Hanser Publishers 1983, incorporated herein by reference.

The following examples are intended to illustrate the example without restricting its scope.

### EXAMPLES

### Example 1

11.42 g (50 mmol) bisphenol A and 11.24 g (52.5 mmol) diphenyl carbonate were placed in a 100 mol round-bottomed flask conforming substantially to the one shown in the figure equipped with a bottom and overhead thermometers. The flask was immersed in an oil bath preheated to 270° C. While the contents were stirred, the time and the temperature at the head and at the bottom required for the first drop of phenol to drip from the end of the distillation column were measured. The results are summarized in Table 1.

### Example 2

Same as Example 1, except that the diphenyl carbonate that was used was made impure by adding to it 100 ppm phenyl piperidyl urethane. The results are summarized in Table 1.

### Example 3

Same as Example 1, except that 1.2 mg (0.004 mol% relative to bisphenol A, added as a mixed crystal with 30 wt.% phenol relative to the mixed crystal) tetraphenyl phosphonium phenolate were added as catalyst. The results are summarized in Table 1.

TABLE 1
Summary of results.

| | Time to 1^{st} drop | Bottom | Overhead |
|---|---|---|---|
| Example | [min] | temperature [° C.] | temperature [° C.] |
| 1 | 33 | 272 | 179 |
| 2 | 15 | 270 | 180 |
| 3 | 6 | 260 | 177 |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for determining the suitability of a raw material entailed in the melt transesterification of polycarbonate, comprising melting reaction raw materials in a reaction vessel and measuring the elapsed time to elimination of the first drop of the hydroxyl compound.

2. The process of claim 1, wherein the reaction vessel comprise a 100 ml round-bottomed flask, equipped with distillation bridge, bottom thermometer, and overhead thermometer.

3. The process of claim 1, wherein the tested raw material is bisphenol.

4. The process of claim 3, wherein bisphenol is bisphenol A.

5. The process of claim 1, wherein the tested raw material is diaryl carbonate.

6. The process of claim 1 wherein the tested raw material is diphenyl carbonate.

7. The process of claim 1 wherein tested raw material is a catalyst.

8. A method of using the process of claim 1 comprising producing polycarbonate.

9. Process for manufacturing Polycarbonate comprising the process according to claim 1.
